(19) United States
(12) Patent Application Publication
(10) Pub. No.: US 2015/0355071 A1
(43) Pub. Date: Dec. 10, 2015

(54) SYSTEM FOR OPTICAL SORTING OF MICROSCOPIC OBJECTS

(71) Applicant: DANMARKS TEKNISKE UNIVERSITET, Lyngby (DK)

(72) Inventor: Jesper GLÜCKSTAD, Frederiksberg (DK)

(73) Assignee: Danmarks Tekniske Universitet, Lyngby (DK)

(21) Appl. No.: 14/759,876

(22) PCT Filed: Feb. 4, 2014
(86) PCT No.: PCT/DK2014/050027

§ 371 Date: Jul. 8, 2015

(30) Foreign Application Priority Data
Feb. 4, 2013 (EP) 13153942.1

(51) Int. Cl. G01N 15/14; B01L 3/00

(52) U.S. Cl. CPC G01N 15/14; B01L 3/502761; B01L 3/502715; G01N 2015/149; B01L 2300/0654; B01L 2200/0652; B01L 2300/0861

(57) ABSTRACT

The present invention relates to a system for optical sorting of microscopic objects and corresponding method. An optical detection system (52) is capable of determining the positions of said first and/or said second objects. One or more force transfer units (200, 205, 210, 215) are placed in a first reservoir, the one or more force units being suitable for optical momentum transfer. An electromagnetic radiation source (42) yields a radiation beam (31, 32) capable of optically displacing the force transfer units from one position to another within the first reservoir (1R). The force transfer units are displaced from positions away from the first objects to positions close to the first objects, and then displacing the first objects via a contact force (300) between the first objects and the force transfer units facilitates an optical sorting of the first objects and the second objects.

### FIELD OF THE INVENTION

The present invention relates to a system for optical sorting microscopic objects, and in particular to a system, method and use of such system for sorting microscopic objects, such as biological cells, using electromagnetic radiation and one or more force transfer units.

### BACKGROUND OF THE INVENTION

For many applications it would be advantageous to be able to sort microscopic objects in a time-efficient manner. As an example, sorting of cells so as to isolate Circulating Tumour Cells (CTCs), is mentioned.

A general problem with optical sorting systems is, that although they work in a relatively straightforward manner when applied to model systems, they face problems when applied to biological systems, for example when applied to sorting of biological cells.

The problems stem from the fact that the forces which a light beam can exert on a particle in such an optical sorting system, scales with the difference in refractive index of the particle with respect to the refractive index of the surroundings. While the objects to be sorted in model systems may be freely chosen so as to have a suitable refractive index (i.e. much higher than the refractive index of water), biological cells—unfortunately—have a refractive index almost similar to water due to their high water content. The water-like refractive index of the biological objects to be sorted necessitates that the power is turned up (i.e. a “brighter” light source is used), but this risks damaging the biological objects.

International patent application WO 2006032844 to Univ. of St. Andrew discloses a method for sorting/separating at least two different particles in a fluid, the method comprising defining within the fluid a static optical landscape/pattern having one or more optical wells or troughs that are substantially the same size or slightly larger than at least one of the particles. By exploiting differing particle responses to the same light pattern, separation/sorting can be done. This type of sorting may potentially be performed to separate particles that are of different sizes, shapes or refractive indices. In one particular embodiment, the problem of having similar refractive index of the biological cells etc. with the surrounding fluid, such as water, is mitigated by attachment of colloidal particles of higher refractive index, which receive most of scattering and refraction from laser field. This colloidal particle can act as a cargo carrier in this instance. However, this solution has the inherent problem of both attaching the high refractive index so-called cargo carrier to the particle of interest and subsequently after sorting, detaching the cargo carrier from the particle of interest.

Hence, an improved optical sorting system would be advantageous, and in particular a more efficient and/or gentle sorting system would be advantageous.

### SUMMARY OF THE INVENTION

It is a further object of the present invention to provide an alternative to the prior art.

In particular, it may be seen as an object of the present invention to provide a sorting system that solves the above mentioned problems of the prior art by being gentle and efficient.

Thus, the above described object and several other objects are intended to be obtained in a first aspect of the invention by providing a system for sorting microscopic objects comprising:
a first reservoir suitable for containing microscopic objects suspended in a first fluid, the microscopic objects comprising first objects and second objects, the first and second objects being different from each other,
an optical detection system capable of determining the positions of said first and/or said second objects,
one or more force transfer units placed in, or near, the first reservoir, the one or more force units being suitable for optical momentum transfer,
an electromagnetic radiation source arranged for providing an electromagnetic radiation beam capable of optically displacing the one or more force transfer units from one position to another within, adjacent or close to, the first reservoir, and
a controller arranged for obtaining said positions of the first and/or the second objects, from the optical detection system and correspondingly control the electromagnetic radiation source so as to selectively displace the force transfer units from positions away from the first objects to positions close to the first objects, and subsequently displacing the first objects via a contact force between the first objects and the force transfer units thereby facilitating an optical sorting of the first objects and the second objects, such as facilitating an optical sorting of the first objects and the second objects which does not require optically displacing, such as directly optically displacing, the first objects and/or the second objects.

The invention may be particularly, but not exclusively, advantageous for obtaining a system capable of sorting microscopic objects in a more efficient manner while being sufficiently gentle toward the sorted objects, such as biological cells.

By ‘microscopic object’ is understood an object of microscopic dimensions, such as particles, beads or micro devices having lengths, width and height within a range from 1 nanometre to 1 millimetre, such as within a range from 1 nanometre to 100 micrometres, such as within a range from 1 nanometre to 10 micrometres, such as within a range from 1 nanometre to 1 micrometre. In some definitions, ‘microscopic’ is defining as not being visible to the normal human eye. As a special case microscopic object includes mesoscopic particles, mesoscopic particles typically being defined as particles with a dimension in the range from ca. 100-1000 nm (nanometre).

‘Electromagnetic radiation’ (EMR) is well-known in the art. EMR is understood to include various types of electromagnetic variation, such as various types corresponding to different wavelength ranges, such as radio waves, microwaves, infrared radiation, EMR in the visible region (which humans perceive or see as ‘light’), ultraviolet radiation, X-rays and gamma rays. The term optical is to be understood as relating to light. EMR is also understood to include radiation from various sources, such as incandescent lamps, LASERs and antennas. It is commonly known in the art, that EMR may be quantized in the form of elementary particles known as photons. In the present application, the terms ‘light’ and ‘optical’ is used for exemplary purposes. It is understood, that where ‘light’ or ‘optical’ is used it is only used as an example of EMR, and the invention is understood to be applicable to also other wavelength intervals where reference is made to ‘light’ or ‘optical’.

By ‘suspended’ is understood that the microscopic objects are kept in the fluid phase in the fluid channel, such as floating within the fluid channel, such as not being placed adjacent to, such as being in contact with, the outer walls of the fluid channel due to gravity or buoyancy. In particular embodiments, the fluid channel is understood to comprise a suspension, such as a fluid with suspended microscopic objects, where the microscopic objects would eventually, after a period of time, settle at the bottom of the fluid channel due to gravity (sedimentation) or settle at the top of the fluid channel due to buoyancy (creaming). In other particular embodiments, the fluid channel is understood to comprise a colloid, such as a colloidal suspension, such as a fluid with suspended microscopic objects, where the microscopic objects do settle, such as sediment, or otherwise fall out of solution.

By ‘sorting microscopic objects’ is understood a physical separation of one or more microscopic objects. The microscopic objects may be sorted by moving, such as isolating the microscopic objects of interest, or the opposite namely removing the microscopic objects which are not of interest i.e. so-called positive and negative sorting, respectively. Possibly, a combination of positive and negative sorting may be implemented within the teaching and principle of the present invention. It is further understood, that in more advanced embodiments, sorting may include sorting into more than two groups, i.e. not only sorting into microscopic objects of interest and microscopic objects which are not of interest, but subdividing and sorting the microscopic objects further into different groups.

By ‘detection system’ is understood a system capable of determining a set of one or more positions of one or more microscopic objects suspended in the fluid. More particularly, the detection system is a system capable of determining the presence and position of a plurality of microscopic objects within the fluid. More particularly, the detection system is a system capable of determining the presence and position of a plurality of microscopic objects, such as the first and/or second objects, within the fluid. The detection system may be a system capable of determining the presence and position of a plurality of microscopic objects, such as force transfer units, such as force transfer units within the fluid, such as force transfer units suspended in the fluid. It may be understood, that the positions of the plurality of microscopic objects, such as the first and/or second objects and/or the force transfer units, within the fluid corresponds to a plurality of positions within the fluid, such as an independent position for each microscopic object in the fluid, such as enabling moving a force transfer unit, such as a specific force transfer unit, from a position away from a specific microscopic object to a position close to the specific microscopic object. It may be understood, that the detection system yields a spatial resolution which enables distinguishing the independent positions from each other, such as not merely determining the presence of a plurality of microscopic objects within the fluid, but also resolving their spatial positions from each other.

In a more particular embodiment, the detection system is a system capable of determining the presence and position of a plurality of microscopic objects suspended in the fluid, such as freely suspended in the fluid, such as suspended in a flowing fluid in the fluid. The detection system may in particular embodiments be able to distinguish between different categories of microscopic objects, such as by distinguishing between objects according to drug-response, size, optical properties, such as fluorescence, size, shape, morphology, charge, radioactivity and/or other properties, such as physical properties.

By ‘position’ is understood at least a position in a 1-dimensional (1D) space (such as an x-coordinate), such as a two-dimensional (2D) space (such as a set of corresponding x- and y-coordinates), such as a three-dimensional (3D) space (such as a set of corresponding x-, y-, and z-coordinates). The detection system may in a particular embodiment comprise a vision system which can identify microscopic objects placed in the fluid channel. In a more particular embodiment, the vision system may further be arranged for distinguishing between microscopic objects, so as to enable categorizing the microscopic objects.

By ‘a set of one or more positions of one or more microscopic objects’ is understood a set of positions, such as set of coordinates in a 1D, 2D or 3D space so that the position of each individual microscopic object within a set of microscopic objects, such as microscopic objects within a certain category of microscopic objects, is described by the set.

By ‘a controller’ is understood a unit capable of receiving information corresponding to the set of one or more positions, and furthermore for controlling the plurality of EMR beams. In a particular embodiment, the controller is a unit comprising a processor. In another particular embodiment, the controller is embodied by a computer, such as a personal computer. It may be understood, that the controller is arranged for automatically, such as without human intervention, controlling the plurality of EMR beams. The controller may be operationally interconnected with peripheral units, such as the means for providing a plurality of spatially controllable EMR beams, a diffractive optical element, such as a spatial light modulator and/or the detection system. An advantage of automatic controlling, such as by computer implemented controlling, may be that it possibly enables faster, cheaper, prolonged and/or more reliable sorting.

The ‘EMR source’ is a source of EMR and may in particular embodiments be a coherent light source, such as a laser. For example, the EMR source can be a monochromatic laser light source or a combination of several monochromatic laser light sources. Lasers which are not strictly monochromatic are also contemplated. A super continuum light source is e.g. referred to as a ‘white light laser’. When several lasers are employed, they can operate simultaneously or in a time-multiplexed manner. It is also contemplated to use a specific wavelength of electromagnetic trapping or EMR, such as 830 nm (which has the advantage that at this wavelength there may be less risk of damaging biological tissue), such as 488 nm, such as 633 nm (which corresponds to a typical HeNe laser), such as 532 nm, such as 1070 nm, such as 1064 nm (which corresponds to a typical ND:YAG laser), such as 532 nm, such as 1550 nm (which has the advantage that it is well suited for transmittance through optical fibers), such as 2 micron or higher. Lasers can be CW or pulsed, the pulsed laser can for example be applied in an embodiment with cavitation bubbles used as force transfer unit.

It may be understood that ‘displacing the first objects via a contact force between the first objects and the force transfer units’ is carried out so as to sort the first objects and the second objects, such as to sort the first objects and the second objects via the contact force.

It may be understood, that ‘displacing the first objects via a contact force (300) between the first objects and the force transfer units’, comprises displacing the first objects, via said contact force, from a first region, such as the first region comprising first objects and second objects before sorting, to a second region, where the second region after sorting comprises first objects and no or relatively few second objects, such as first objects and no or few second objects, such as first objects and no second objects, such as only first objects. By ‘relatively few second objects’ may be understood, that the ratio between first objects and 20 second objects in the second region after sorting is higher than the same ratio in the first region before sorting.

It may be understood, that ‘displacing the first objects via a contact force between the first objects and the force transfer units thereby facilitating an optical sorting of the first objects and the second objects’, enables an optical sorting of the first objects and the second objects which does not require optically displacing, such as directly optically displacing, the first objects and/or the second objects, such as any of the first objects and/or second objects. By ‘directly optically displacing’ of an object, may be understood that displacement of the object is an effect of the photons of the electromagnetic radiation beam interacting directly with the object, such as propagating through and/or being reflected from the object. It may be understood, that embodiments of the present invention may be gentle to the first objects since it is displacing the first objects via a contact force between the first objects and the force transfer units, which in turn enables facilitating an optical sorting of the first objects and the second objects which does not require optically displacing, such as directly optically displacing, the first objects and/or the second objects. Thus, a strong force from the electromagnetic radiation source may be transferred to the first objects via the force transfer units (via the contact force), so as to reduce or eliminate the risk of damaging the first objects, such as biological objects, with the electromagnetic radiation.

Preferably, the contact force between the force transfer units and the first objects may be an approximately momentary transfer of impulse from a force transfer unit to a first object, depending of course on the fluid medium (e.g. viscosity and flow) and optical displacement provided, e.g. optical momentum available etc. It is to be understood that multiple transfer of impulse between a force transfer unit and a first object may be required to obtain a desirable physical displacement of the first object. Nevertheless, each of the transfer of impulses is typically of a quite short character, e.g. below sub-seconds, below around 10 milliseconds, below 100 milliseconds, or below 500 milliseconds. To some extent the force transfer units and the first object may be analogous to a macroscopic billiard ball situation where momentum is transferred from one ball to the other.

Advantageously, the contact force does not involve any chemical bonding, such as any permanent chemical bonding, between the force transfer units and the first objects, e.g. bonding having covalent, ionic, or hydrogen bonding, etc., character, thereby not requiring unbonding after completion of the sorting process. This is often the cause for other prior art sorting methods using carrier units being bonded, such as chemically bonded, such as permanently chemically bonded, to the desirable objects for sorting, e.g. WO 2006032844. The wording of ‘permament’ may be understood to refer to and/or emphasize that the chemical bonding is relevant under ‘practical circumstances’, such as the permanent chemical bonding being a bonding understood to last a duration of time at least comparable to the duration of the sorting process.

It may be understood, that a first object and a force transfer unit which are not permanently chemically bonded to each other will not remain bonded to each other after, such as immediately after, the optical sorting of the first objects and the second objects, such as not requiring unbonding in order to separate said first object and said force transfer unit.

It may be understood, that the no permanent chemical bonding (i.e., the absence of permanent chemical bonding) enables that the electromagnetic radiation source may be controlled so as to move the force transfer unit away from the first object. It may be understood, that the contact force between a force transfer unit and the first and second object is repulsive, such as purely repulsive, such as exclusively repulsive.

It may be understood, that the contact force between a force transfer unit and the first and second object is arranged so that any attractive force between a force transfer unit and the first and second object is too weak to enable moving, such as to enable moving under practical circumstances, the first and/or second objects via the contact force between a force transfer unit and the first and second object.

It may be understood, that the contact force is arranged so that Brownian motion may overcome any attractive component of the contact force, such as any attractive component of the contact force being too weak to keep the force transfer unit and the first or second particle together. Brownian motion may be understood to be Brownian motion under practical circumstances, such as at standard ambient conditions for temperature and pressure (such as a temperature of 298.15 K (25° C., 77° F.) and an absolute pressure of 100 kPa (14.504 psi, 0.987 atm)) and/or at human body temperature and pressure (such as a temperature of 37° C. (98.6° F.) and an absolute pressure of 100 kPa (14.504 psi, 0.987 atm)).

It may be understood that the contact force is arranged so as to enable that the system is being arranged for enabling
the electromagnetic radiation source to selectively displace the force transfer units from positions away from the first objects to positions close to the first objects, and subsequently
displacing the first objects via a contact force between the first objects and the force transfer units thereby facilitating an optical sorting of the first objects and the second objects, such as thereby facilitating an optical sorting of the first objects and the force transfer units, and subsequently
selectively displace the force transfer units from positions close to the first objects to positions away from the first objects, such as so as to enable providing a pure selection of the first objects, such as so as to enable providing a pure selection of the first objects without force transfer units.

In an embodiment, the controller is furthermore arranged to, subsequent to displacing the first objects via a contact force (300) between the first objects and the force transfer units thereby facilitating an optical sorting of the first objects and the second objects,
selectively displace the force transfer units from positions close to the first objects to positions away from the first objects, such as so as to enable providing a pure selection of the first objects, such as so as to enable providing a pure selection of the first objects without force transfer units.

The controller may furthermore be arranged to control the electromagnetic radiation source so as to selectively displace the force transfer units from positions away from the first objects to positions close to the first objects, and subsequently displacing the first objects via a contact force between the first objects and the force transfer units thereby facilitating an optical sorting of the first objects and the second objects, and subsequently to selectively displace the force transfer units from positions close to the first objects to positions away from the first objects, such as so as to enable providing a pure selection of the first objects, such as so as to enable providing a pure selection of the first objects without force transfer units.

Within the context of the present application, it is understood that ‘force units’ and ‘force transfer units’ are used interchangeably. It is understood, that the force transfer units are different from the first objects. It may be understood, that the force transfer units are different from the first objects and the second objects.

In some embodiments, the first objects may be displaceable during sorting to a second reservoir, the second reservoir for example being in fluid contact with first reservoir. This can be beneficial for the overall sorting process. The second reservoir may comprise a second fluid, the second fluid being either identical to the first fluid, or different from the first fluid. In the latter case, the fluids may be separated physically (e.g. by a filter, temperature differences, separate laminar flows) or chemically (e.g. not soluble in each other). As it will be explained later, the present invention may of course be generalised to any number of fluids, and/or any number of reservoirs, as it will be readily understood by the skilled person in microscopic optical fluid based sorting. Advantageously, the first and/or the second reservoir may comprise, or be part of, a first fluid channel and/or a second fluid channel, one or both channels preferably being suited for housing a laminar flow of fluid.

Preferably, the first reservoir and/or the second reservoir may comprise one or more optical traps providing an optical potential energy landscape for entrapment as it may be beneficial for entrapment of the first objects, the second objects, and/or the force transfer units. The optical entrapment may be performed by the same EMR beams performing the optical displacement of the force transfer units, or they may be additional EMR beams provided by the system.

In some advantageous embodiments, the said first and/or said second objects are mesoscopic objects (typically being defined as objects in-between macroscopic objects and microscopic/nanoscale objects, with a size approximately in the interval of 100-1,000 manometers), macro-molecules, polymers, or biological cells, such as vira, bacteria, stem cells, sperm cells, cancer cell, ovarian, blood, relative rare cells in mammals, etc., the present invention thereby offering a valuable way of sorting such objects.

In some embodiments, the force transfer units may be microscopic particles, such as polymer particles (e.g. polystyrene, PS), metal particles or metal alloy particles (e.g. TiO₂, SiO₂) including magnetic particles. In particular magnetic particles are well suited for beneficial use because of relatively easy separation from the first objects after sorting is completed, particular also if the fluid is recirculated for multiple sorting processes. In some embodiment, the force transfer units may be reflection-coated particles to enhance the optical momentum transfer as it will be readily realized by the skilled person in optical sorting and trapping.

In a particular embodiment, the force transfer units may comprise one or more optical or electromagnetically active metamaterials, the metamaterial being tailored to applications within a context of the present invention. Thus, by using metamaterials, it is possible to synthesize materials with advanced permittivity and permeability particularly useful for the force transfer unit because the available optical momentum transfer can be significantly enhanced relative to conventional optical displacement using e.g. a dielectric material such as a polymer. Some examples of suitable optical metamaterials include, but are not limited to, metals and plastics being arranged with periodic patterns, the periodicity of the pattern being generally smaller, preferably much smaller, than the wavelength of the light that the metamaterial is intended to interact with. In an embodiment, the metamaterial may be applied to yield a negative refractive index, though other non-conventional optical effects may also be applied within the teaching and general principle of the present invention.

In another particular advantageous embodiment, the force transfer units may be microscopic particles having an exterior shape chosen from the group consisting of: spherical shape, disc-like shape, elongated rod shape, parabola shape, spherical shape with spikes or other elongated structures extending from the surface of the spherical shape. In particular, the microscopic particles may have a topology with optimised shapes for optimal light-matter interaction with respect to inter alia precision of optical displacement, maximal momentum transfer, optimum force transfer to the first objects, etc. Thus, their exterior shape may be particular tailored to the properties of being a force transfer unit within the context of the present invention, for example using an optical lifting effect with a light foil being uniformly radiated, or a microscopic light-driven rotor with photons transferring momentum selectively to the rotor ‘blades’, etc., as explained in more detail in “Sculpting the object” by the present inventor, Jesper Glückstad, Nature Photonics, 5, (7-8), 2011, which is hereby incorporated by reference in its entirety.

In another embodiment, the force transfer object may be a microscopic particle but further being tied to a surface or similar by microscopic links, e.g. polymers, such as DNA polymers attached to the force transfer units and a mounting surface. In that way, the force transfer unit can be freely displaced, within maximum reach of the microscopic link or ‘chain’, while at the same time being restricted to a limited volume thereby avoiding for example the need for sorting the first objects and the force transfer units later on.

In some embodiments, the force transfer units may be microscopic particles that are being manufactured by photopolymerisation, such as two-photon photopolymerisation, preferably produced at the site of sorting, or other similar micro-manufacturing methods available to the skilled person in optical sorting.

In other embodiments, the force transfer unit may be one or more liquid interfaces, such as microscopic liquid bubbles, e.g. droplets with a diameter of less than 500 micrometer, within the first fluid, microscopic gas bubbles within the first fluid, or a macroscopic liquid interface between the first fluid and another fluid, e.g. two immiscible liquid, such as oil and water etc. In one particular embodiment, the droplet may be a light induced cavitation within the liquid where the first objects is suspended or floating.

In some embodiment, the force transfer unit may comprise liquid crystal material due the optical adjustable properties of such materials, i.e. the liquid crystal material may be irradiated by a first EMR beam adjusting its optical properties, e.g. modifying the refractive index, and a second EMR beam may optical displace the force transfer unit using the just-adjusted optical properties, and thereby possibly significantly improving the possible optical displacement of the force transfer unit.

In some embodiment, the force transfer unit may be a membrane adjacent to the first fluid, the membrane being suitable for optical momentum transfer in order to provide the contact force for displacement of the first objects. This could for example be a membrane made of amorphous silicon having suitable optical properties for selectively and local displacement applicable for use within the context of the present invention. Alternatively, an array of optically displaceable micropistons could be implemented.

In some embodiments, the force transfer units are different compared to said first and/or said second objects. An advantage thereof might be that the difference enables distinguishing between the force transfer units and the first and/or second objects.

In some embodiments, the force transfer units may have a relatively high refractive index as compared to said first and/or said second objects, preferably the force transfer objects have a refractive index being at least 10% larger than the first and/or the second objects. Alternatively, the refractive index could be at least 20% larger, 30% larger, 40% larger, 50% larger, or 100% larger than the first and/or the second objects. It is contemplated that other optical properties may significantly differ as well.

In advantageous embodiments, the force transfer unit may be capable of having optically induced one or more of the following effects: photophoretic, electrophoretic, dielectrophoretic, photochemical, and photomagnetic, or other similar optical effects. Thus, similar to the liquid crystal embodiments mentioned above, the force transfer unit may be irradiated by a first EMR beam adjusting or modifying its optical properties or introducing new optical effects, and a second, subsequent EMR beam may then optical displace the force transfer unit using the new optical properties, and thereby possibly significantly improving the possible optical displacement of the force transfer unit. This beneficially opens for optical displacements with a force being several orders of magnitude higher.

As an example, a photochemical induced reaction of the force transfer unit could significantly increase the speed of the force transfer unit, and the subsequent EMR beam could be applied for controlling the direction of the increased speed. An example of a photochemical reaction could be a light un-encagement reaction where light is applied to release molecules from the force transfer unit thereby facilitating an increased speed.

As another example, a pulsed laser could be applied to induce a photophoretic effect in the force transfer unit resulting in a higher speed of the force transfer units. Particles with a suitable light absorbing layer may be used in this context.

In a second aspect, the present invention relates to a method for optical sorting of microscopic objects, the method comprising:
providing a first reservoir suitable for containing microscopic objects suspended in a first fluid, the microscopic objects comprising first objects and second objects, the first and second objects being different from each other,
determining, with an optical detection system, the positions of said first and/or said second objects,
providing one or more force transfer units placed in, or near, the first reservoir, the one or more force units being suitable for optical momentum transfer,
optically displacing the one or more force transfer units from one position to another within, adjacent or close to, the first reservoir, using an electromagnetic radiation source arranged for providing an electromagnetic radiation beam, and
providing a controller for obtaining said positions of the first and/or the second objects, from the optical detection system and correspondingly control the electromagnetic radiation source so as to selectively displace the force transfer units from positions away from the first objects to positions close to the first objects, and subsequently displacing the first objects via a contact force between the first objects and the force transfer units thereby facilitating an optical sorting of the first objects and the second objects.

Advantageously, the present invention may be implemented on an existing optical sorting system modified according to the teaching and general principle of the present invention, e.g. by modifying the EMR beam providing and/or the controller, and by providing suitable force transfer units.

In a further embodiment, the method further comprises, subsequent to displacing the first objects via a contact force (300) between the first objects and the force transfer units thereby facilitating an optical sorting of the first objects and the second objects,
selectively displacing the force transfer units from positions close to the first objects to positions away from the first objects, such as so as to enable providing a pure selection of the first objects, such as so as to enable providing a pure selection of the first objects without force transfer units.

In an embodiment of the invention, there is provided an optical sorting system according to the first aspect, the method further comprising:
determining, with the optical detection system, positions of said first and/or said second objects,
optically displacing the one or more force transfer units from one position to another within, adjacent or close to, the first reservoir, using an electromagnetic radiation source arranged for providing an electromagnetic radiation beam, and
obtaining said positions of the first and/or the second objects, from the optical detection system
control the electromagnetic radiation source based on the positions of said first and/or said second objects, so as to selectively displace the force transfer units from positions away from the first objects to positions close to the first objects, and subsequently
displacing the first objects via a contact force between the first objects and the force transfer units thereby facilitating an optical sorting of the first objects and the second objects.

It may be understood that the optical sorting of the first objects and the second objects is taking place as a result of the contact force between the first objects and the force transfer units. It may be understood, that the method enables sorting first objects without optically displacing the first objects. The method may furthermore comprise:
subsequently selectively displacing the force transfer units from positions close to the first objects to positions away from the first objects, such as thereby facilitating an optical sorting of the first objects and the force transfer units.

In a third aspect, the invention relates to a computer program product being adapted to enable a computer system comprising at least one computer having data storage means in connection therewith to control a system according to the first aspect of the invention.

This aspect of the invention is particularly, but not exclusively, advantageous in that the present invention may be accomplished by a computer program product enabling a computer system to carry out the operations of the system of the first aspect of the invention when down- or uploaded into the computer system. Such a computer program product may be provided on any kind of computer readable medium, or through a network. In particular, the present invention may thereby be implemented on an existing optical sorting system modified according to the teaching and principle of the present invention.

The first, second and third aspect of the present invention may each be combined with any of the other aspects. These and other aspects of the invention will be apparent from and elucidated with reference to the embodiments described hereinafter.

### BRIEF DESCRIPTION OF THE FIGURES

The system, method and use according to the invention will now be described in more detail with regard to the accompanying figures. The figures show one way of implementing the present invention and are not to be construed as being limiting to other possible embodiments falling within the scope of the attached claim set.

FIG. 1 shows a system for sorting microscopic objects,

FIG. 2 shows the system of FIG. 1 with more details,

FIG. 3 shows a system according to the present invention for sorting microscopic objects using microscopic particles as force transfer units,

FIG. 4 shows a system according to the present invention for sorting microscopic objects using microscopic liquid interfaces e.g. liquid or gas droplets as force transfer units,

FIG. 5 shows another system according to the present invention for sorting microscopic objects using an optically susceptible membrane as a force transfer unit,

FIG. 6 shows another system according to the present invention for sorting microscopic objects using a macroscopic liquid-liquid interface as a force transfer unit,

FIG. 7 shows various microscopic particle embodiments of the force transfer unit according to the present invention,

FIG. 8 shows a system according to the present invention for sorting microscopic objects with one fluid inlet and one fluid outlet,

FIG. 9 shows a system according to the present invention for sorting microscopic objects with one fluid inlet and two fluid outlets,

FIG. 10 shows a system according to the present invention for sorting microscopic objects with two fluid inlets and two fluid outlets,

FIG. 11 shows a generalised system according to the present invention for sorting microscopic objects with N fluid inlets, K reservoirs, and M fluid outlets, and

FIG. 12 is a flow chart of a method according to the invention.

### DETAILED DESCRIPTION OF AN EMBODIMENT

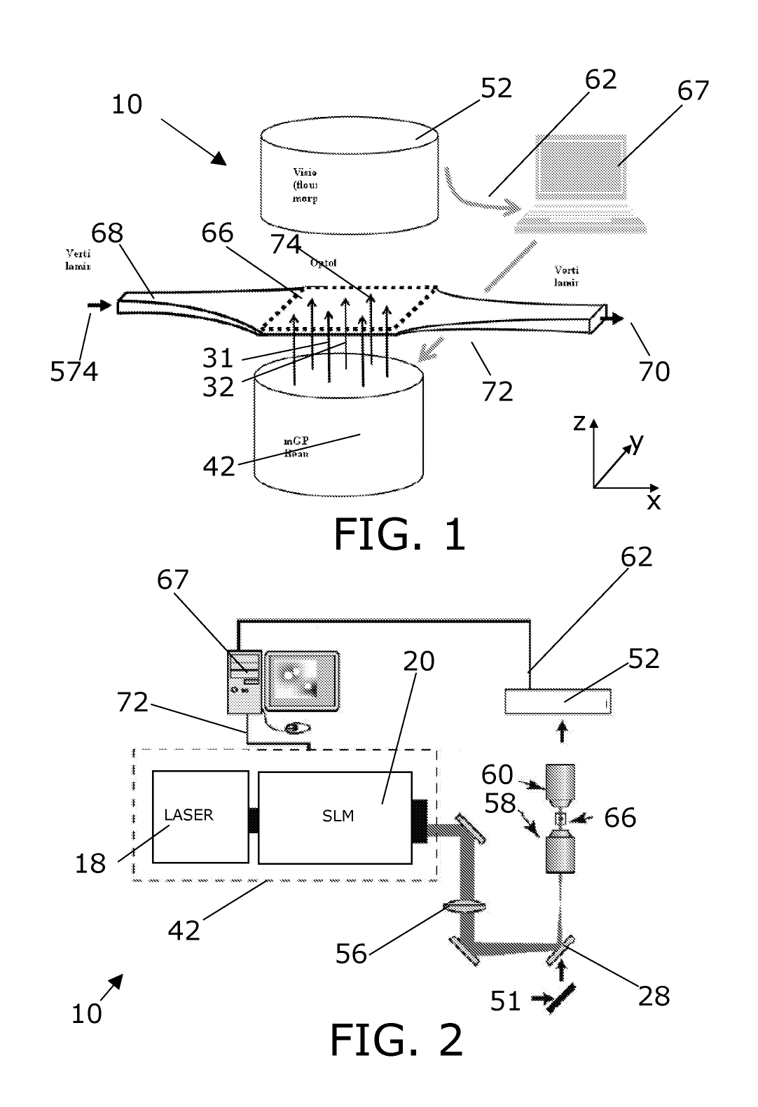

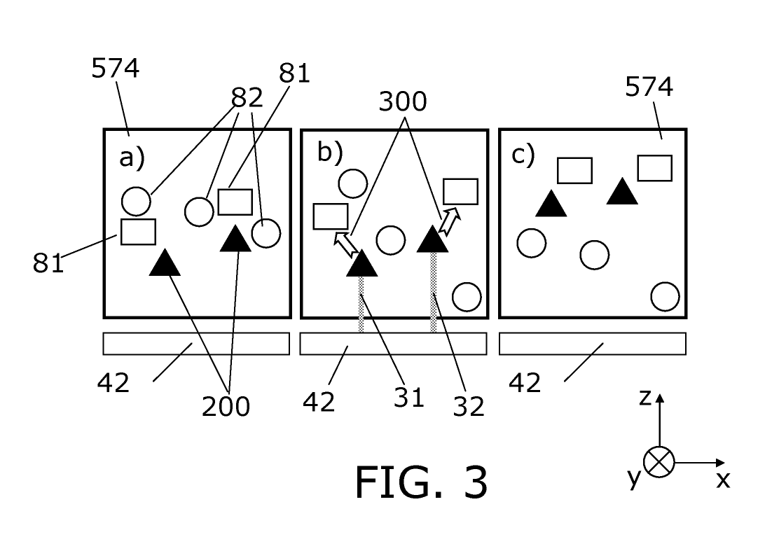

FIG. 1 shows a system 10 for sorting microscopic objects 81 and 82 using force transfer units 200, the units in this embodiment being microscopic objects also suspended in a fluid 574, flowing from left to right as indicated by the horizontal arrows, together with microscopic objects 81 and 82 not shown in FIG. 1 for clarity but shown for example in FIG. 3.

The system comprises
a fluid channel 66 comprising an inlet 68 and an outlet 70, the fluid channel being dimensioned so as to allow a flow of fluid between the inlet and the outlet to be laminar,
a detection system 52 for determining a set of one or more positions of one or more microscopic objects in the fluid channel, and
means 42 for providing a plurality of EMR beams 31, 32 being independently spatially controllable and propagating into the fluid channel. The EMR beams are preferably reconfigurable depending on the circumstances.

The system also comprises a controller 67, such as a processor or a computer, arranged for
obtaining the set of one or more positions from the detection system 52 as indicated by arrow 62, and
control the plurality of EMR beams 31, 32 being emitted from EMR providing means 42, e.g. a laser, based on the set of one or more positions, so as to enable each of the EMR beams in the plurality of EMR beams to exert a force on a force transfer unit 200, 205, 210, and 215, cf. FIG. 3-6, such as sending instructions as indicated by arrow 62 to the means 42 for providing a plurality of EMR beams 31, 32 in order to control the spatial positions of the plurality of EMR beams 31, 32,
   wherein the force preferably, but not necessarily, has a direction component being parallel with a primary axis z. The primary axis can be parallel with the EMR beam and orthogonal to a direction x of the flow of fluid, so as to enable sorting of the microscopic objects by displacing them spatially along the primary axis z. It is noted that the fluid channel 66 also comprises region 74 in which the microscopic objects are to be sorted, which region may be bounded by one or more transparent walls, such as windows. The coordinate system in the lower right corner of FIG. 1 shows three axes, namely the x-axis which in the present figure is horizontal left-right and directed to the right, the z-axis which is vertical up-down and directed upwards, and the y-axis which is in the plane of the paper note that FIG. 1 is a perspective drawing and directed into the paper. The primary axis is parallel with the z-axis, which is also parallel with a direction of propagation of the plurality of EMR beams 31, 32. The fluid flow is preferably parallel with the x-axis, i.e., the fluid flows from left to right. Each of the beams within the plurality of EMR beams 31, 32 may exert a force, such as a net force, on a force transfer unit, which force is preferably parallel with the direction of propagation of the beam, i.e., directed in the z-direction. The fluid flow is in the x-direction, which in the present figure is orthogonal to the z-direction; it is noted that the x- and z-directions need not necessarily be mathematically orthogonal to each other, however, they cannot be parallel. The detection system 52 may be a vision based system. The detection system 52 may determine the set of one or more positions of the one or more microscopic objects in the fluid channel based on the properties of the microscopic objects in the fluid channel, including but not being limited to their colour, fluorescence and/or morphology, such as size and/or shape.

Though not shown in FIG. 1, the present invention may be applied with a recirculation of fluid i.e. sorting the same fluid one or more additional time, for example to obtain a higher degree of sorting, purity, concentration, etc. In some embodiments, the force transfer units may also be reused, if appropriate separation of the force transfer units is provided, e.g. magnetic separation for reuse, optical sorting of force transfer units themself or other separation technique conceivable by the skilled person.

FIG. 2 shows the system 10 of FIG. 1 with more details regarding the means 42 for providing a plurality of EMR beams 31, 32. In particular, FIG. 2 shows means 42 for providing a plurality of EMR beams 31, 32 which further comprises a light source 18, which is a LASER light source, and a spatial light modulator 20 (SLM). The light source 18 emits light through the spatial light modulator 20 which modulates the light so as to provide a plurality of beams which may be directed to the fluid channel 66 via optical elements, such as via lens 56 and mirror 28. FIG. 2 furthermore shows that illumination light 51 may also be emitted through the fluid channel 66, so as to improve the capabilities of the detection system 52 in terms of obtaining the set of one or more positions of one or more microscopic objects in the fluid channel 66.

In a particular embodiment, the detection means may employ a stereoscopic imaging system, such as an imaging system which enables providing 3D information regarding the positions of the microscopic objects in the flow channel by providing at least two offset images separately. The EMR beams as well as the illumination light may be transmitted via a lower objective 58 to the fluid channel, and an upper objective may further enhance the improve the capabilities of the detection system 52 in terms of obtaining the set of one or more positions of one or more microscopic objects in the fluid channel 66.

In a particular embodiment, the means 42 for providing a plurality of EMR beams being independently spatially controllable and propagating into the fluid channel may be embodied by the so-called BioPhotonics Workstation. The BioPhotonics Workstation is described in the reference “Independent trapping, manipulation and characterization by an all-optical biophotonics workstation”, by H. U. Ulriksen et al., J. Europ. Opt. Soc. Rap. Public. 3, 08034 (2008), which is hereby incorporated by reference in its entirety. The BioPhotonics Workstation uses near-infrared light (A=1,064 nm) from a fibre laser (IPG). Real-time spatial addressing of the expanded laser source in the beam modulation module produces reconfigurable intensity patterns. Optical mapping of two independently addressable regions in a computer-controlled spatial light modulator SLM as counter propagating beams in the sample volume, enables trapping a plurality of micro-objects (currently generates up to 100 optical traps). The beams are relayed through opposite microscope objectives (Olympus LMPLN 50×IR, WD=6.0 mm, NA=0.55) into a 4.2 mm thick Hellma cell (250 μm×250 μm inner cross section). A user traps and steers the desired object(s) in three dimensions through a computer interface where the operator can select, trap, move and reorient cells and fabricated micro devices with a mouse or joystick in real-time. Videos of the experiments are grabbed simultaneously from the top-view and side-view microscopes. It is understood when referring to ‘trap’ or ‘trapping’ that trapping is a particular example in which scattering forces are applied, but where the scattering forces a balanced by other forces (which may also be scattering forces).

FIG. 3 shows a schematic system according to the present invention for sorting microscopic objects using microscopic particles as force transfer units 200 (symbolically marked as solid triangles). In the present embodiment, there is not shown any flow in the fluid 574 but it is possible to perform a sorting of the microscopic first objects 81 (symbolically marked as squares) and microscopic second objects 82 (symbolically marked as circles).

The outer square schematically indicates a first reservoir suitable for containing the microscopic objects 81 and 82 suspended in the first fluid 574, the microscopic objects comprising first objects 81 and second 82 objects, the first and second objects being different from each other, e.g. chemically and/or biologically resulting in different optical properties detectable by the optical detection system according to the present invention.

The one or more force transfer units 200 are placed in the first reservoir, the one or more force units being suitable for optical momentum transfer by the EMR beams 31 and 32.

In means 42 an electromagnetic radiation source is provided, arranged for providing one or more electromagnetic radiation beams capable of optically displacing the one or more force transfer units 200 from one position to another within the first reservoir.

The optical detection system correspondingly controls the electromagnetic radiation source and the beams 31 and 32 so as to selectively displace the force transfer units 200 from positions away from the first objects 81 to positions close to the first objects 81, and subsequently displacing the first objects via a contact force 300, as indicated by arrow, between the first objects 81 and the force transfer units 200 thereby facilitating an optical sorting of the first objects 81 and the second objects 82. Thus, as seen in FIG. 3 the first objects 81 are in the upper half of the reservoir, the second objects been in the lower half of the reservoir thereby performing a positive sorting of the first objects 81. The first and/or the second objects can then subsequently be further conveyed, manipulated, separated from the fluid, etc. as it will be understood by a skilled person in microscopic sorting.

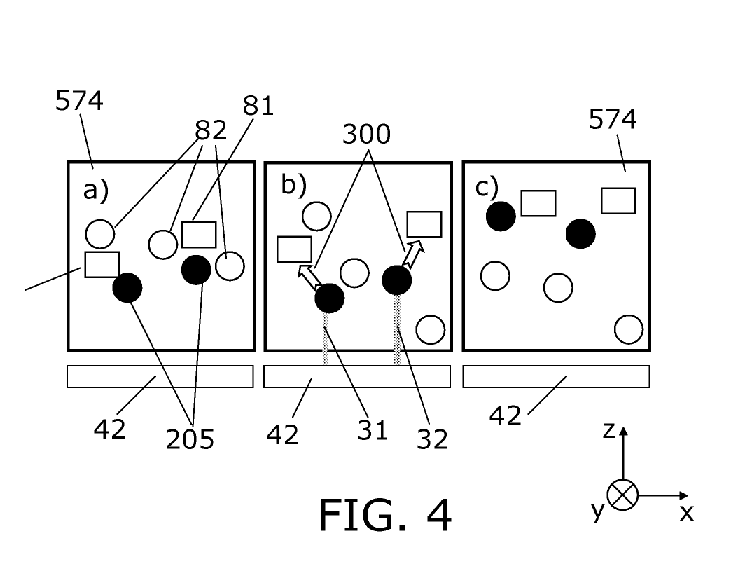

FIG. 4 shows a schematic system according to the present invention for sorting microscopic objects similarly to the system shown in FIG. 3 but instead using microscopic liquid interfaces e.g. liquid or gas droplets as force transfer units. In one embodiment, the droplets could alternatively be cavities created for example by a pulsed laser. The force transfer units 205 are thus microscopic droplets suspended, or embedded, in the fluid 574. The force transfer units 205 or microscopic droplets have appropriate optical properties for facilitating optical momentum transfer from EMR beams 31 and 32 to the units 205 thereby enabling physical displacement of the force transfer units 205 towards the first objects 81 and—via contact forces 300—perform physical displacement of the first objects 81 resulting in sorting of the microscopic objects 81 and 82 similar to the embodiment shown in FIG. 3.

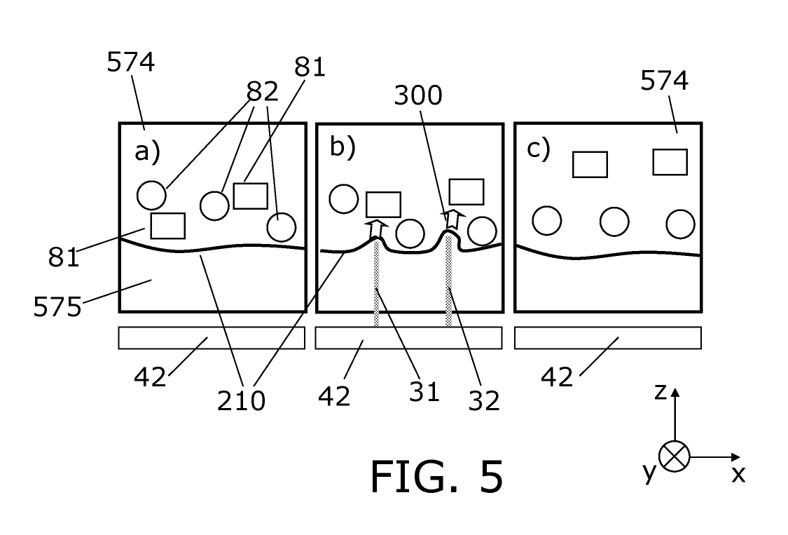

FIG. 5 schematically shows another system according to the present invention for sorting microscopic objects using an optically susceptible membrane as a force transfer unit 210. In this particular embodiment, the force transfer unit may be considered a common macroscopic entity i.e. a membrane but having sites or areas that optically susceptible and therefore may be displaced as indicated in FIG. 5. By appropriate determination of the position of the first objects 81 and corresponding control of the EMR beams 31 and 32, the membrane may be selectively displaced and thereby provide contact forces 300 acting on first objects 81 in order to sort first objects 81 from second objects 82. It will be understood that the membrane may be somewhat limited in the possible displacement towards the first objects 81, for example due to fixation in the fluid 574, and the optical displacement should take this into account when used for sorting.

The membrane 210 may be suspended in the fluid 574 i.e. having the same fluid on both side of the membrane, or the membrane 210 may separate different fluids, i.e. fluid 574 being a liquid, and the fluid 575 may be another fluid, e.g. liquid or gas.

The membrane 210 may be a micro-thin flexible amorphous silicon array of optically susceptible sites, e.g. a collection of microscopic membranes or so-called micro-pistons together forming a larger membrane, or other similar materials.

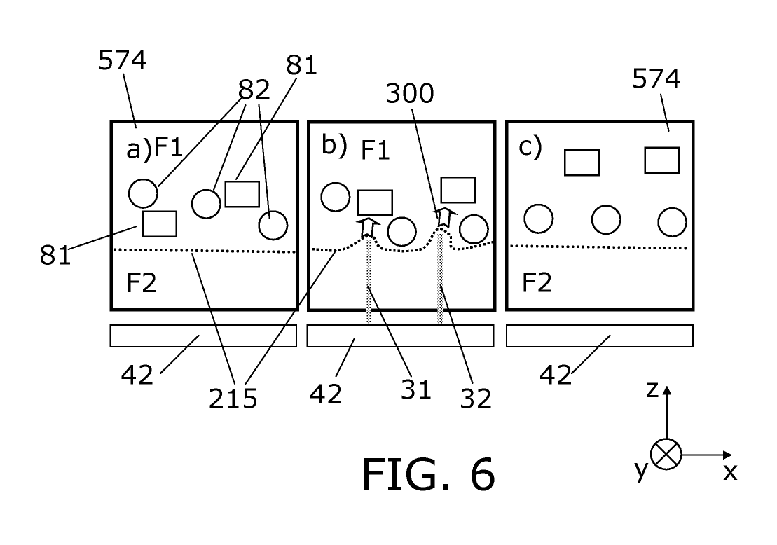

FIG. 6 schematically shows another system according to the present invention for sorting microscopic objects 81 and 82 similar to FIG. 5 but instead of a membrane using a macroscopic liquid-liquid interface as a force transfer unit 215. Thus, the interface may be formed by two immiscible liquids (flowing or non-flowing), where the interface due to the combined optical properties of the interface will effectively act like a force transfer unit 215 in an analogue situation to the membrane of FIG. 5. Thus, by controlling the EMR beams 31 and 32, it is possible to perform optical sorting of the first 81 and second 82 objects.

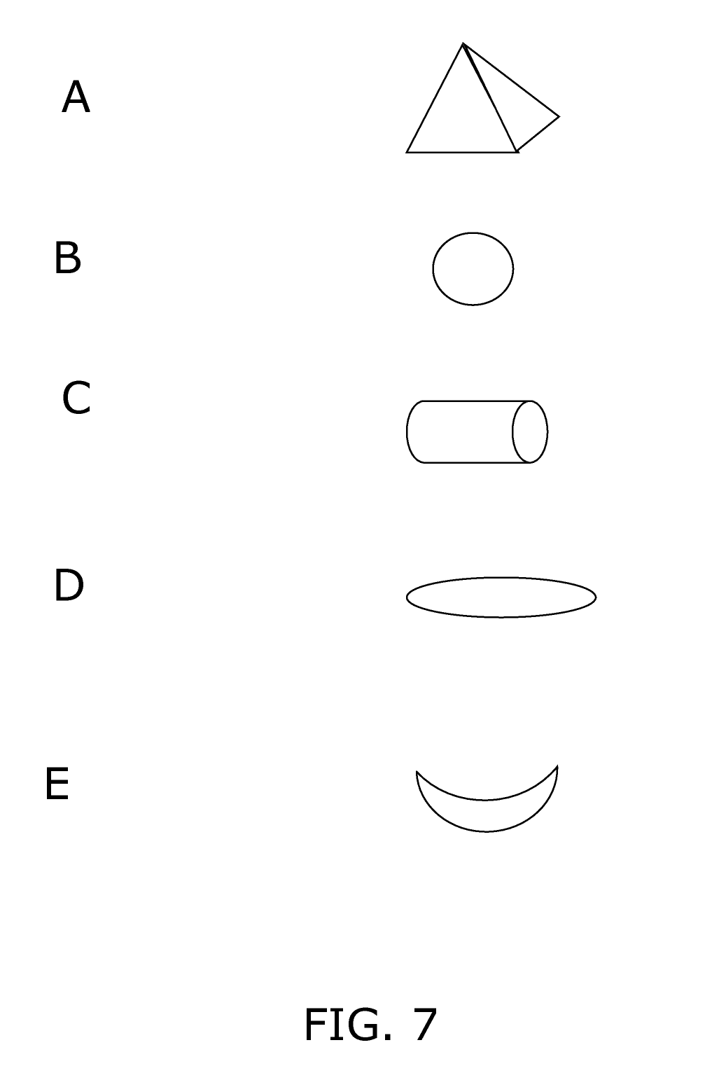

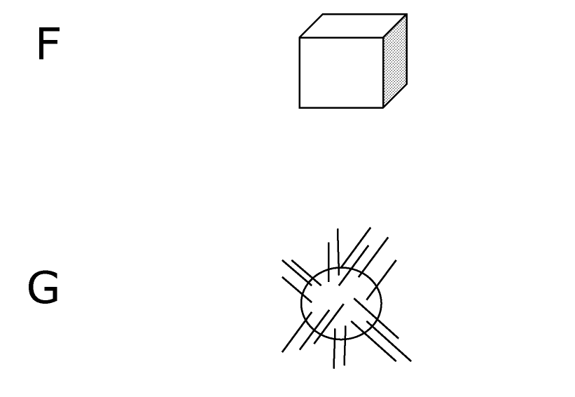

FIG. 7 shows various microscopic particle embodiments of the force transfer unit according to the present invention similar to the embodiment of FIG. 3, where a microscopic particle is used as force transfer unit 200.

In FIG. 7 A, the force transfer unit has the outer shape of a pyramid or a 3-dimensional triangle. Such shapes may for example be manufactured by two-photo polymerization.

In FIG. 7 B, the force transfer unit has a spherical shape. Thus, the force transfer unit may for example be high-reflectivity metal beads, e.g. titania beads. It could also be magnetically susceptible beads particularly suited for being magnetically separate from the fluid after sorting.

In FIG. 7 C, the force transfer unit has the outer shape of a rod. In FIG. 7 D, the force transfer unit has the shape of a disc or an ellipsoid. In FIG. 7 E, the force transfer unit has the outer shape of a parabola. In FIG. 7 F, the force transfer unit has the shape of box or cube. Such shapes may all be manufactured by two-photo polymerization or other suitable micro manufacturing method readily available to the skilled person. In particular, the optical and mechanical properties of the force transfer unit may be tailored to the specific sorting task i.e. in dependency of the objects to be sorted and the EMR beams available for providing force transfer.

In FIG. 7 G, the force transfer unit has the shape of a bead with elongated spikes to better support objects that are sorted by the contact force, e.g. partly absorbing the contact force to protect the microscopic objects to be sorted, for example fragile biological cells.

Any of the shown shapes in FIG. 7 A to FIG. 7 G may be combined, or used simultaneously during a sorting process according to the present invention. In particular, the force transfer units 200, 205, 210, and/or 215 may be connected (physically and/or chemically), e.g. 2, 3, 4, 5 or more units together, in order to provide a larger contact force and/or large spatial volume for transferring contact force 300.

The shapes of FIG. 7, or other shapes, may particularly be used to tailor the topology of the light-matter interaction in order to provide force transfer units with advantageous properties, e.g. a microscopic light-driven rotor with photons transferring momentum selectively to the rotor ‘blades’, or other optical driven micro-machines being applied in the context of the present invention, cf. for example “Sculpting the object” by the present inventor, Jesper Glückstad, Nature Photonics, 5, (7-8), 2011, which is hereby incorporated by reference in its entirety.

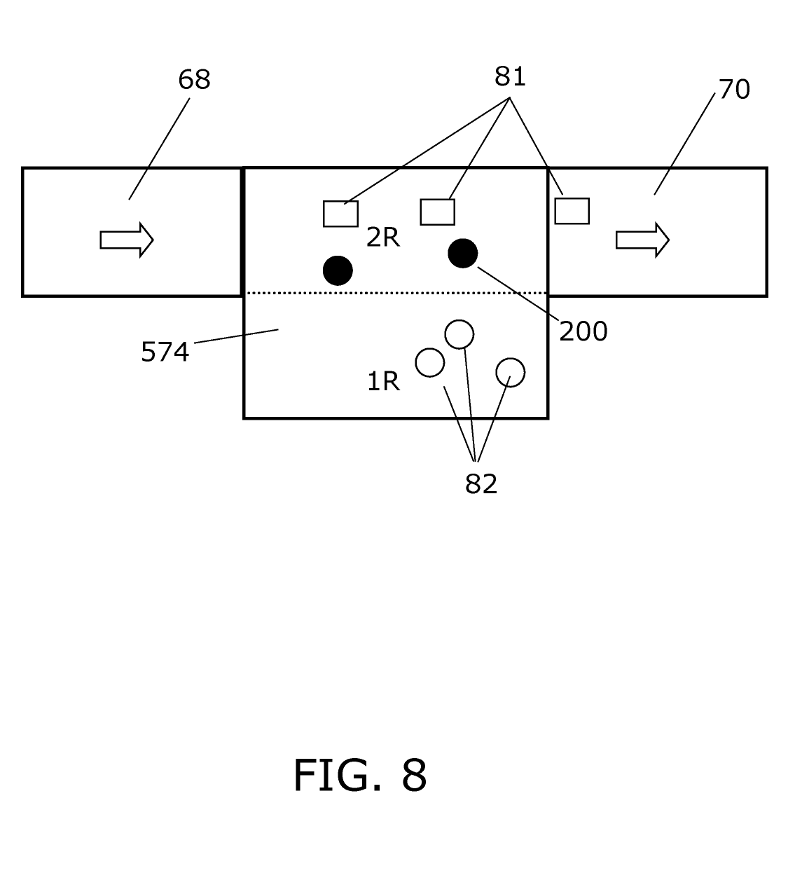

FIG. 8 schematically shows a system according to the present invention for sorting microscopic objects with one fluid inlet 68 and one fluid outlet 70. The first objects 81 are displaceable during sorting by force transfer unit 200, cf. FIG. 3, to a second reservoir 2R, the first and second objects being originally both in the first reservoir 1R suspended in fluid 574. The second reservoir 2R may comprise a 30 second fluid that could be flowing as indicated by arrows in the inlet and outlet, respectively. The second fluid could be identical to the first fluid. Alternative the second fluid could be different from the first fluid, e.g. separated either physical (filter, temperature, flow) or chemical (first and second fluid not being soluble in each other). In particular, the inlet 68 and the outlet 70 could provide a laminar flow of fluid, not being mixed with the fluid in the first reservoir 1R.

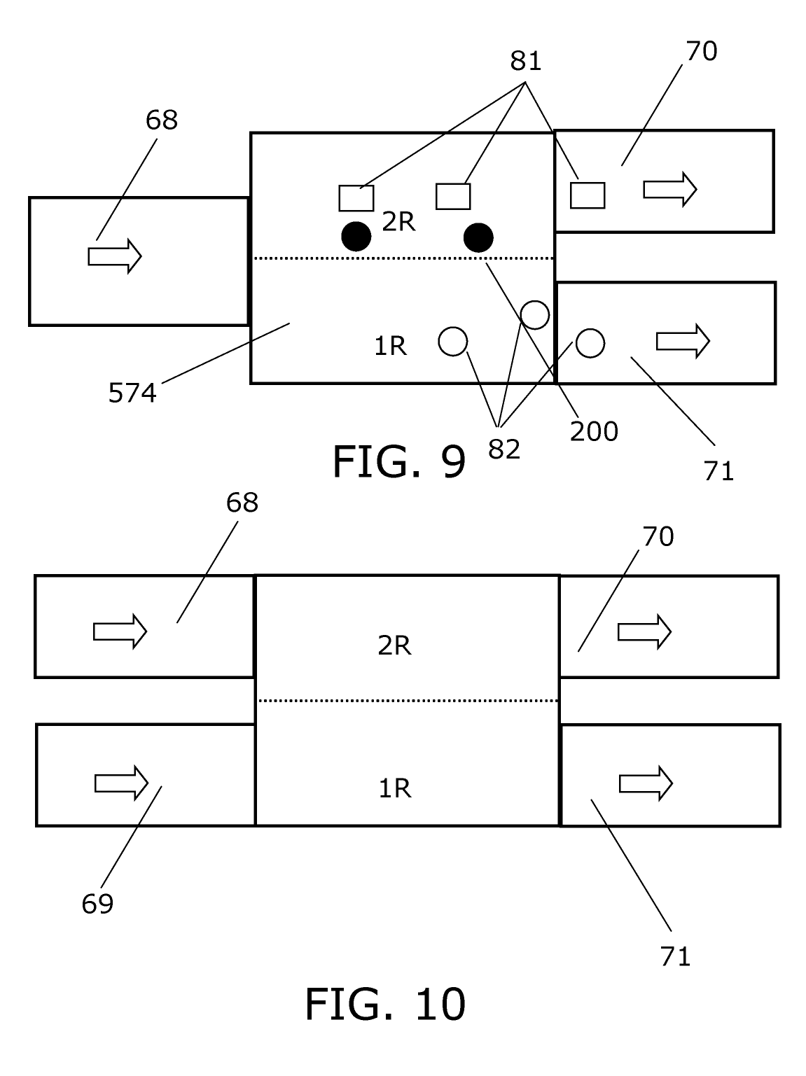

FIG. 9 shows a system according to the present invention for sorting microscopic objects with one fluid inlet 68 similarly to the embodiment shown in FIG. 8 but with two fluid outlets 70 and 71, respectively. The two outlets provide efficient sorting, or filtering, of the first 81 and second 82 microscopic objects being conveyed away from the first 1R and the second 2R reservoir, respectively with the corresponding flow.

FIG. 10 shows a similar system to the systems shown in FIG. 8 and FIG. 9 according to the present invention for sorting microscopic objects with two fluid inlets 68 and 69 and two fluid outlets 70 and 71. This could for example be advantageous if chemical substances and/or biological objects are provided from separate inlets 68 and 69, and they perform chemical and/or biological reactions or transformations in the first and/or second reservoir. After the reactions or transformations, the resulting products can be sorted at, or near, the actual place of formation, different products being conveyed in separate outlets 70 and 71, respectively.

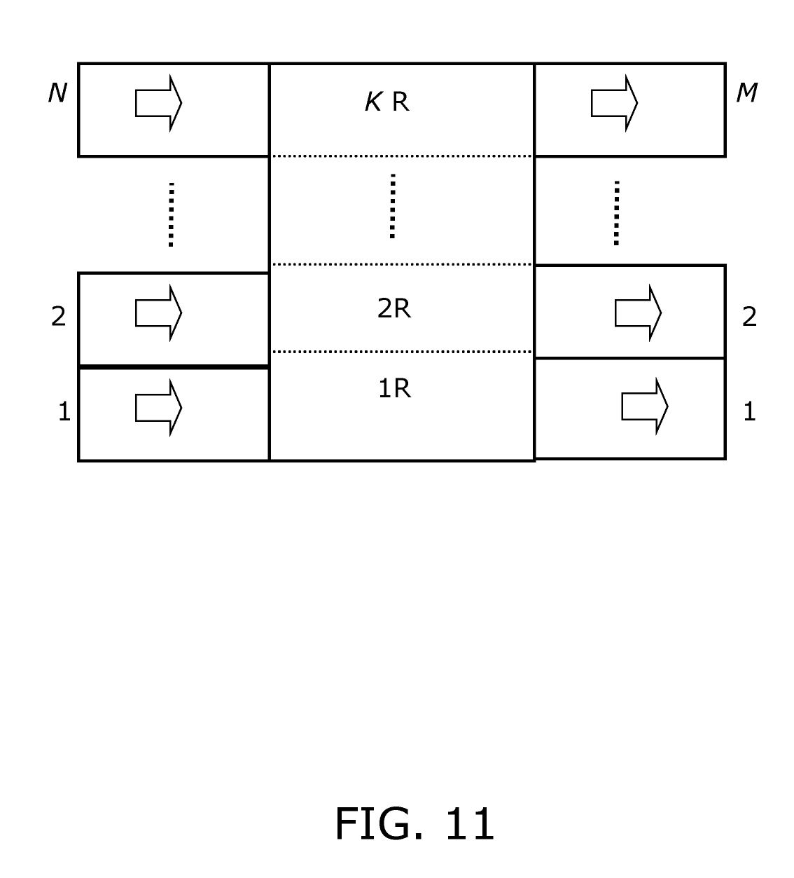

FIG. 11 shows a generalised system according to the present invention for sorting microscopic objects with N fluid inlets, K reservoirs, and M fluid outlets, N, K, and M being any integer, e.g. 0, 1, 2, 3, 4, 5, 6, etc., appropriate for the biological transformations and/or chemical reactions, and subsequent sorting process as desired.

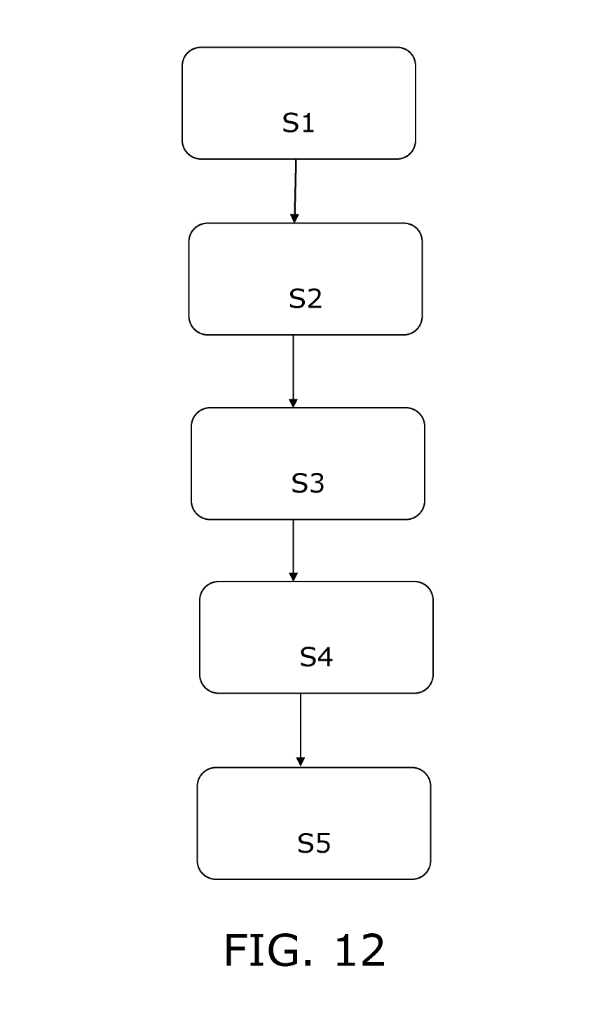

FIG. 12 is flow chart of the method for optical sorting of microscopic objects according to the present invention, the method comprising:
S1 providing a first reservoir suitable for containing microscopic objects suspended in a first fluid, the microscopic objects comprising first objects 81 and second 82 objects, the first and second objects being different from each other,
S2 determining, with an optical detection system 52, the positions of said first and/or said second objects,
S3 providing one or more force transfer units 200, 205, 210, 215 placed in, or near, the first reservoir, the one or more force units being suitable for optical momentum transfer,
S4 optically displacing the one or more force transfer units from one position to another within, adjacent or close to, the first reservoir, using an electromagnetic radiation source 42 arranged for providing an electromagnetic radiation beam,
S5 providing a controller 67 for obtaining said positions of the first and/or the second objects, from the optical detection system and correspondingly control the electromagnetic radiation source so as to selectively displace the force transfer units from positions away from the first objects to positions close to the first objects, and subsequently displacing the first objects via a contact force 300 between the first objects and the force transfer units thereby facilitating an optical sorting of the first objects and the second objects.

Summarizing, the present invention relates to a system for optical sorting of microscopic objects. An optical detection system 52 is capable of determining the positions of said first and/or said second objects. One or more force transfer units 200, 205, 210, or 215 are placed in a first reservoir, the one or more force units being suitable for optical momentum transfer. An electromagnetic radiation source 42 yields a radiation beam 31 and 32 capable of optically displacing the force transfer units from one position to another within the first reservoir 1R. The force transfer units are displaced from positions away from the first objects to positions close to the first objects, and then displacing the first objects via a contact force 300, cf. FIG. 3-6, between the first objects and the force transfer units facilitates an optical sorting of the first objects and the second objects.

In exemplary embodiments E1-E16 there is provided:
E1. A system for optical sorting of microscopic objects, the system comprising:
   a first reservoir suitable for containing microscopic objects suspended in a first fluid, the microscopic objects comprising first objects (81) and second (82) objects, the first and second objects being different from each other,
   an optical detection system (52) capable of determining the positions of said first and/or said second objects,
   one or more force transfer units (200, 205, 210, 215) placed in, or near, the first reservoir, the one or more force units being suitable for optical momentum transfer,
   an electromagnetic radiation source (42) arranged for providing an electromagnetic radiation beam capable of optically displacing the one or more force transfer units from one position to another within, adjacent or close to, the first reservoir, and
   a controller (67) arranged for obtaining said positions of the first and/or the second objects, from the optical detection system and correspondingly control the electromagnetic radiation source so as to selectively displace the force transfer units from positions away from the first objects to positions close to the first objects, and subsequently displacing the first objects via a contact force (300) between the first objects and the force transfer units thereby facilitating an optical sorting of the first objects and the second objects.
E2. The system according to embodiment E1, wherein the contact force between the force transfer units and the first objects is an approximately momentary transfer of impulse from a force transfer unit to a first object.
E3. The system according to embodiment E1, wherein the contact force does not involve any permanent chemical bonding between the force transfer units and the first objects.
E4. The system according to embodiment E1, wherein the first objects are displaceable during sorting to a second reservoir, the second reservoir comprising a second fluid, the second fluid being identical to the first fluid, or different from the first fluid.
E5. The system according to embodiment E1 or E4, wherein the first reservoir and/or the second reservoir comprises one or more optical traps providing an optical potential energy landscape for entrapment.
E6. The system according to embodiment E4, wherein the first and/or the second reservoir comprises, or be part of, a first fluid channel and/or a second fluid channel, preferably suited for housing a laminar flow of fluid.
E7. The system according to embodiment E1, wherein said first and/or said second objects are mesoscopic objects, macro-molecules, polymers, or biological cells, such as vira, bacteria, stem cells, sperm cells, cancer cells, ovarian cells, blood cells of any kind, or relatively rare cells.
E8. The system according to embodiment E1, wherein the force transfer units are microscopic particles, such as polymer particles, metal particles or metal alloy particles, incl. magnetic particles.
E9. The system according to embodiment E8, wherein the force transfer units are microscopic particles having an exterior shapes chosen from the group consisting of: spherical shape, disc-like shape, elongated rod shape, parabola shape, spherical shape with spikes or other elongated structures extending from the surface of the spherical shape.
E10. The system according to embodiments E1, E8 or E9, wherein the force transfer units are microscopic particles being manufactured by photopolymerisation, such as two-photon photopolymerisation.
E11. The system according to embodiment E1, wherein the force transfer unit is one or more liquid interfaces, such as microscopic liquid bubbles within the first fluid, microscopic gas bubbles within the first fluid, or a macroscopic liquid interface between the first fluid and another fluid.
E12. The system according to embodiment E1, wherein the force transfer unit is a membrane adjacent to the first fluid, the membrane being suitable for optical momentum transfer in order to provide the contact force for displacement of the first objects.
E13. The system according to embodiment E1 or any of embodiments E8-E10, wherein the force transfer units has a relatively high refractive index as compared to said first and/or said second objects, preferably the force transfer objects have a refractive index being at least 10% larger than the first and/or the second objects.
E14. The system according to embodiment E1, wherein the force transfer unit is capable of having optically induced one or more of the following effects: photophoretic, electrophoretic, dielectrophoretic, photochemical, and photomagnetic.
E15. A method for optical sorting of microscopic objects, the method comprising:
   providing a first reservoir suitable for containing microscopic objects suspended in a first fluid, the microscopic objects comprising first objects (81) and second (82) objects, the first and second objects being different from each other,
   determining, with an optical detection system (52), the positions of said first and/or said second objects,
   providing one or more force transfer units (200, 205, 210, 215) placed in, or near, the first reservoir, the one or more force units being suitable for optical momentum transfer,
   optically displacing the one or more force transfer units from one position to another within, adjacent or close to, the first reservoir, using an electromagnetic radiation source (42) arranged for providing an electromagnetic radiation beam, and
   providing a controller (67) for obtaining said positions of the first and/or the second objects, from the optical detection system and correspondingly control the electromagnetic radiation source so as to selectively displace the force transfer units from positions away from the first objects to positions close to the first objects, and subsequently displacing the first objects via a contact force (300) between the first objects and the force transfer units thereby facilitating an optical sorting of the first objects and the second objects.
E16. A computer program product being adapted to enable a computer system comprising at least one computer having data storage means in connection therewith to control an optical sorting system according to embodiment E1.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A system for optical sorting of microscopic objects, the system comprising:
a first reservoir suitable for containing microscopic objects suspended in a first fluid, the microscopic objects comprising first objects and second objects, the first and second objects being different from each other,
an optical detection system capable of determining the positions of said first and/or said second objects,
one or more force transfer units placed in, or near, the first reservoir, the one or more force units being suitable for optical momentum transfer,
an electromagnetic radiation source arranged for providing an electromagnetic radiation beam capable of optically displacing the one or more force transfer units from one position to another within, adjacent or close to, the first reservoir, and
a controller arranged for obtaining said positions of the first and/or the second objects, from the optical detection system and correspondingly control the electromagnetic radiation source so as to selectively displace the force transfer units from positions away from the first objects to positions close to the first objects, and subsequently displacing the first objects via a contact force between the first objects and the force transfer units thereby facilitating an optical sorting of the first objects and the second objects,
wherein the contact force does not involve any permanent chemical bonding between the force transfer units and the first objects.

2-20. (canceled)

21. The system according to claim 1, wherein the contact force between the force transfer units and the first objects is an approximately momentary transfer of impulse from a force transfer unit to a first object.

22. The system according to claim 21, wherein the momentary transfer of impulse is less than a second.

23. The system according to claim 1, wherein the contact force does not involve any permanent chemical bonding between the force transfer units and the first objects, thereby not requiring unbonding after completion of the sorting process.

24. The system according to claim 1, wherein
displacing the first objects via a contact force between the first objects and the force transfer units thereby facilitating an optical sorting of the first objects and the second objects,
enables an optical sorting of the first objects and the second objects which does not require optically displacing the first objects and/or the second objects.

25. The system according to claim 1, wherein the first objects are displaceable during sorting to a second reservoir, the second reservoir comprising a second fluid, the second fluid being identical to the first fluid, or different from the first fluid.

26. The system according to claim 1, wherein the first reservoir and/or the second reservoir comprises one or more optical traps providing an optical potential energy landscape for entrapment.

27. The system according to claim 25, wherein the first and/or the second reservoir comprises, or is a part of, a first fluid channel and/or a second fluid channel.

28. The system according to claim 1, wherein said first and/or said second objects are mesoscopic objects, macro-molecules, polymers, or biological cells.

29. The system according to claim 1, wherein the force transfer units are microscopic particles.

30. The system according to claim 29, wherein the force transfer units are microscopic particles having exterior shapes selected from the group consisting of: spherical shape, disc-like shape, elongated rod shape, parabola shape, spherical shape with spikes and spherical shape with elongated structures extending from the surface of the spherical shape.

31. The system according to claim 1, wherein the force transfer units are microscopic particles that are manufactured by photopolymerisation.

32. The system according to claim 1, wherein the force transfer unit is one or more liquid interfaces.

33. The system according to claim 1, wherein the force transfer unit is a membrane adjacent to the first fluid, the membrane being suitable for optical momentum transfer in order to provide the contact force for displacement of the first objects.

34. The system according to claim 1, wherein the force transfer units has a high refractive index as compared to said first and/or said second objects.

35. The system according to claim 1, wherein the force transfer unit is capable of having optically induced one or more of the following effects: photophoretic, electrophoretic, dielectrophoretic, photochemical, or photomagnetic.

36. The system according to claim 1, wherein the controller is furthermore arranged to, subsequent to displacing the first objects via a contact force between the first objects and the force transfer units thereby facilitating an optical sorting of the first objects and the second objects,
selectively displace the force transfer units from positions close to the first objects to positions away from the first objects.

37. A method for optical sorting of microscopic objects, the method comprising:
providing a first reservoir suitable for containing microscopic objects suspended in a first fluid, the microscopic objects comprising first objects and second objects, the first and second objects being different from each other,
determining, with an optical detection system, the positions of said first and/or said second objects,
providing one or more force transfer units placed in, or near, the first reservoir, the one or more force units being suitable for optical momentum transfer,
optically displacing the one or more force transfer units from one position to another within, adjacent or close to, the first reservoir, using an electromagnetic radiation source arranged for providing an electromagnetic radiation beam, and
providing a controller for obtaining said positions of the first and/or the second objects, from the optical detection system and correspondingly control the electromagnetic radiation source so as to selectively displace the force transfer units from positions away from the first objects to positions close to the first objects, and subsequently displacing the first objects via a contact force between the first objects and the force transfer units thereby facilitating an optical sorting of the first objects and the second objects,
wherein the contact force does not involve any permanent chemical bonding between the force transfer units and the first objects.

38. The method for optical sorting of microscopic objects according to claim 37, further comprising, subsequent to displacing the first objects via a contact force between the first objects and the force transfer units thereby facilitating an optical sorting of the first objects and the second objects,
selectively displacing the force transfer units from positions close to the first objects to positions away from the first objects.

39. The method for optical sorting of microscopic objects according to claim 37, the method further comprising:
displacing the first objects via a contact force between the first objects and the force transfer units,
comprising displacing the first objects, via said contact force, from a first region to a second region, where the second region after sorting comprises first objects and no second objects.

40. A computer program product being adapted to enable a computer system comprising at least one computer having data storage in connection therewith to control an optical sorting system according to claim 1.
